(19) United States
(12) Patent Application Publication
(10) Pub. No.: US 2025/0346748 A1
(43) Pub. Date: Nov. 13, 2025

(54) Method of Manufacturing Bioplastic Derived from Oatmeal Residue

(71) Applicant: Provinica Interests, LLC, San Antonio, TX (US)

(72) Inventors: Guillermo Flores Cordero, Torreon (MX); Daniel Quihuis Cital, Torreon (MX); Juan Carlos Lares Hopkins, Torreon (MX)

(73) Assignee: Provinica Interests, LLC, San Antonio, TX (US)

(21) Appl. No.: 19/169,412

(22) Filed: Apr. 3, 2025

(30) Foreign Application Priority Data
Apr. 3, 2024 (MX) MX/A/2024/004121

(51) Int. Cl. C08L 23/12

(52) U.S. Cl. CPC C08L 23/12

(57) ABSTRACT

A method of manufacturing bioplastic derived from oatmeal residue comprises producing a mixture of oat waste, polypropylene, additives, plasticizers and lubricants that can be applied in plastic injection, extrusion and thermoforming processes. The process is performed at a very economical cost due to the fact that the formulation is derived from post-industrial waste or by-products of the food and agricultural industry, which for the majority are considered as garbage. this invention of bioplastic from oat waste aims to reduce the carbon footprint, reduce the degradation times of plastic products at the lowest possible cost. In an alternative embodiment, an oatmeal hull residue-based bioplastic is disclosed.

### CROSS REFERENCE TO RELATED APPLICATIONS

This original non-provisional patent application claims priority to and the benefit of Mexican Patent Application No. MX/a/2024/004121, filed Apr. 3, 2024, and entitled “Procedimiento para Elaborar Bioplastico a Partir de Residuos de Avena,” which is incorporated by reference herein for all purposes.

### STATEMENT REGARDING FEDERALLY SPONSORED RESEARCH OR DEVELOPMENT

None.

### BACKGROUND OF THE INVENTION

### 1. Technical Field of the Invention

The present invention relates to biodegradable and plastic materials, or bioplastics. More specifically, the present invention relates to a method or process for the manufacture of bioplastic products derived from oatmeal residue.

### 2. State of the Art

The use of plastics to manufacture goods can be seen in just about every industry ranging from the food industry (e.g., food trays and utensils) to the cosmetics industry (e.g., bottles and container) to the packaging industry (e.g., food containers). However, there are serious environmental concerns raised with the use of plastics. For example, the carbon footprint (CO²) of plastics is 30 tons CO² per 10 tons of material. The energy consumption in the manufacture of plastics is in the range of 22,200 to 33,300 kilowatts/hr. (kWh) usage per ton of material. The water footprint of plastics includes 100 meters cubed of water usage per ton of material. The lifespan of packing made from plastics can take anywhere from 150 to 500 years to decompose.

In the plastic industry, a group of bioplastics was developed as a sustainable (current and future) alternative to help reduce the use of hydrocarbons and pollutants to the environment.

A bioplastic is a type of plastic that comes from renewable biological sources, unlike conventional plastics, which are mainly derived from petroleum (oil) or natural gas. These biological materials can be starch, cellulose, polylactic acids, fibers or even vegetable oils and fats. The idea behind bioplastics is to offer more sustainable and environmentally friendly alternatives compared to traditional plastics.

Bioplastics can be designed to be biobased, biodegradable and compostable, meaning that they can break down naturally under suitable environmental conditions, thus reducing the environmental impact associated with the disposal of plastic waste. However, not all bioplastics are automatically biodegradable or compostable. The properties (biodegradability and compostability) of bioplastics depend on the specific chemical composition and the manufacturing process of the particular bioplastic.

There currently exist plastic products such as food trays, cake domes, chicken packaging, cutlery, cups, plates and any other single-use plastic. Such products can be made through processes that use bioplastics. For example, AU2022272793A1, entitled “Bioplastics based on amyloid fibrils and biodegradable polymers” is directed to the manufacture of composite materials comprising amyloid fibrils and a biodegradable polymer using amyloidogenic protein and a protein of plant origin, preferably oats, peas, soy, potatoes and rice. Another example is US20220112662A1, entitled, “Biocomposite Material” directed to biocomposite materials made of cellulose and wheat bran and/or oat husk prepared by mixing the husk or bran with an aqueous alkaline solution, stirring and/or homogenizing the mixture, mixing the pulp with cellulose, and thermoforming the material under enhanced curing conditions.

Other examples include KR1832204B1 (“Bioplastic with Improved Antimicrobial”), KR1832204B1 (“Bioplastic with Improved Antimicrobial”), CR20230290A (“Bran Biocomposite and Production Method”), CN113272494B (“Biocomposite Material”), and CO2020016206A1 (“Bran Biocomposite and Production Method”). These examples further describe products made through processes that use bioplastics. However, none of these exhibit the advantage of being simultaneously biobased, biodegradable, and compostable.

The oat industry generates hundreds of tons of oat hull residue every day. Some of this residue is used in poultry farms. However, most of this residue ends up in landfills.

There is a need to have a bioplastic product that is biobased, i.e., derived from renewable resources of biological origin as opposed to those derived from fossil resources.

There is also a need to have a bioplastic product that is biodegradable, i.e., a product which can be decomposed by the action of microorganisms such as bacteria, fungi or algae, carbon dioxide and biomass, in a given period.

There is also a need to have a bioplastic product that is compostable, i.e., a product which decomposes and turns into compost or humus, which serves to improve soils, without leaving toxic residues.

There is further a need for a method of manufacturing that can efficiently and economically produce bioplastic products that are simultaneously biobased, biodegradable, and compostable. The present invention addresses and solves the shortcomings recited above.

### BRIEF SUMMARY OF THE INVENTION

The present invention is developed from utilizing discarded oat hull residue to manufacture sustainable food packaging. The present invention produces bioplastic products that are not only biodegradable, but also compostable and biobased.

The present invention comprises the manufacture of bioplastic derived from oat hull residues, or waste, recovered from the oat industry. The bioplastic produced by the present invention is formulated and manufactured based on industrial waste or byproducts of oat grain. The present invention is a sustainable solution for the use of conventional plastic with benefits for the environment and the industry.

The process for the production of bioplastic from oat residue or waste for the manufacture of products for various categories of the plastic, food, agro-industry, cosmetics, packaging industry, among others. The process consists of producing a mixture of oat residue, polypropylene, additives, plasticizers and lubricants that can be applied in plastic injection, extrusion and thermoforming processes. The process is performed at a very economical cost due to the fact that the formulation is derived from post-industrial waste or by-products of the food and agricultural industry, which for the majority are considered or are considered as garbage. The present invention of bioplastic from oat waste reduces the carbon footprint and the degradation times of plastic products at the lowest possible cost.

Through the present invention, there are a series of advantages with respect to the processes to make plastic products. The most characteristic properties of the present invention is that the elements used in oats are byproducts of the Agri-Food industry that have no use and are not considered food due to their low caloric level and poor adaptation, such as oat husk, the stem of the oat plant, roots, pruning, brand and any other ways to generate it by the use of oats.

This makes the present invention completely sustainable and sustainable as the present invention omits food type, such, but not limited to, starches, flours or bran for the formula of the present invention.

This quality of using post-industrial waste also contributes to the oat bioplastic technology of the present invention being much more economical than any other bioplastic on the market.

In addition to the fact that the bioplastic products of the present invention are made with organic residue or waste, such products also come from renewable sources that protect the environment, since the present invention uses products from the field of cyclical production. Nature is not exploited for production of products using the method of the present invention. This, in turn, helps to reduce the carbon footprint of this process.

Variations in technology mean that the methodology of the present invention has adaptability to all plastic processes and any plastic product on the market. Not all bioplastics can be adapted in this way.

Biobased, biodegradable and compostable properties are present in the present invention. This is not found in all bioplastics. Most bioplastics have one or two of these properties (i.e., biobased, biodegradable and compostable), but not all three.

For purposes of this application, the term “residue” is synonymous with “waste.”

### DETAILED DESCRIPTION OF THE INVENTION

The characteristic details of the present invention are clearly shown in the following description of the process for producing bioplastic from oat residue, which is formulated and manufactured based on post-industrial waste or oat by-products generated by the agricultural and food industry, used as a source of fiber to make the bioplastic in question, either using the shell of the oat grain, the stem and pruning of the oat plant, the grain itself and its derivatives such as flours, starches, among others.

The oat waste bioplastic is applied in plastic injection, extrusion, thermoforming and derivative processes to generate different categories of products for the plastics, food, agro-industry, cosmetics, packaging, automotive, household appliance, electronic, furniture, household items, etc. industries.

The fiber derived from oat waste and the granulated polypropylene—sometimes referred to as polypropylene granules, or PP Granules, and that is the base of the plastic in the formula—are the ingredients of the formula that occupy the majority of the volume of the oat waste bioplastic at 96.5%. The bioplastic product to be produced is selected. Once the material is selected according to the product to be developed (produced), the fiber and PP Granules are added and mixed together with 1.5% ADDICO, 1% ethylene-vinyl acetate (EVA) and 1% zinc stearate in a turbo mixer for a predetermined amount of time, for example, for 5 minutes, to obtain a homogeneous mixture. The present invention uses a mixing time of 5 minutes. However, longer or slower periods of time may be used and still remain within the contemplation of the present invention. It is important to mention that the ADDICO product at 1.5% is used as a process improver. A process improver is any additive added and used in adhesive coatings, mold compounds and composites applications. The process improver also is used in the manufacture of industrial coatings such as paints and coatings, by virtue of its chemical resistance and durability properties. Regarding adhesives, Super Gran Masterbatch (SGM), are concentrated pigments or encapsulated additives used to formulate structural and high resistance adhesives in industrial applications due to SGM's ability to form thermosetting resins. The percentages added are on a per weight basis with respect to the final mixture.

The EVA product (ethylene-vinyl acetate) is also added to the mixture as a plasticizer, in a percentage of 1.0% of the mixture, to plasticize and give resistance and elasticity to the manufactured plastic products, such as, but not limited to, polyurethane, polyvinyl chloride (PVC), thermoplastic rubber, silicone, natural or synthetic rubber, and the like.

The 1.0% added zinc stearate provides lubricating, stabilizing and non-stick properties. Magnesium stearate, calcium stearate, aluminum stearate, lithium stearate, sodium stearate, oleamide, polyolefin waxes can also be used in this percentage (i.e., 1%).

In summary, the raw materials and the formulation of the bioplastic manufactured by the present invention are shown in Table 1, as follows:

TABLE 1
Raw materials and formulation

| | | | VARIANTS ACCORDING TO | |
|---|---|---|---|---|
| STANDARD BASE FORMULA | | | THE TYPE OF PRODUCT | |
| PRODUCT | DESCRIPTION | PERCENTAGE | Minimum % | Maximum % |
| OAT FIBER | SPRAYED FIBER | 30% | 1% | 80% |
| polypropylene | PP GRANULATE | 66.5% | 15% | 99% |
| ADDICO Process | ADDITIVE | 1.5% | 0.5% | 7% |
| Improver | | | | |
| EVA | PLASTICIZER | 1.0% | 0.5% | 7% |
| | Resistance, plasticity | | | |
| ZINC STEARATE | LUBRICANT | 1.0% | 0.5% | 7% |

Below, as shown in Table 2, is the standard base formulation for making 100 kilograms of bioplastic from oat residue:

TABLE 2
Standard base formulation. Standard base formula
for 100 kg of oat waste bioplastic

| PRODUCT | PERCENTAGE | KG | TOTAL |
|---|---|---|---|
| OAT FIBER | 30% | 30.00 | 100 kg of oat waste |
| polypropylene | 66.5% | 65.50 | bioplastic |
| ADDICO Process Improver | 1.5% | 1.50 | |
| EVA | 1.0% | 1.00 | |
| ZINC STEARATE | 1.0% | 1.00 | |

Once the oat residue bioplastic mixture is formulated, a pelletizing process is carried out where the material is poured into a hopper that feeds a pelletizer, for predetermined amount of time (5 minutes), then the material or mixture falls into two endless screws. These screws heat the mixture for a predetermined amount of time (3 minutes) causing the mixture to go from a solid state to a viscous state having a homogeneous mixture, and exerting pressure (variable according to the plastic to be made) to improve its fluidity so that the mixture passes through a mesh or net to filter out impurities (e.g., large particles of oats, unmelted plastic or any type of contamination).

The exerted pressure forces the mixture to be injected into a mold. The mold configuration selected is dependent upon the final product to be made (products based on bioplastics in general), and may be in a form resembling noodles or string.

The mixture continues to be transported along a conveyor belt. At least two fans operably connected to the conveyor belt actively cool the material or mixture as same passes. The mixture is then cut using a cutting machine. The resulting pellets formed by the cutting of the mixture then fall into a sieve to separate out any poorly cut materials (of variable dimensions). The material that does not get separated out then falls into a collector, or tub, of the pelletizer. The material or mixture is emptied and collected in 25 kilogram bundles or in 800 kilogram super sacks.

### Examples of Bioplastic Application Technique Based on Oat Residue

### For the Manufacture of Food Trays, Cake Domes or Packaging for Chickens

There are several examples of the application of bioplastic products made under the present invention. Such examples include the manufacture of food trays, cake domes or packaging for chicken products, as further described herein below.

Once the oat residue bioplastic mixture is formulated, the mixture undergoes several processes, including extrusion, thermoforming, and injection. These processes are described below:

Process: Extrusion. Once the material or mixture is mixed, the mixture is poured into a hopper to carry out extrusion processes where the mixture is heated from 180 to 200 degrees Celsius, to melt and couple together and is pushed by two screws, until the mixture reaches the head of the extrusion machine. At that point, the mixture is expelled in a series of rollers where the mixture is then flattened to form an extruded sheet. The extruded sheet is rolled for easy handling and transport. The extruded sheet serves as raw material for the thermoforming process.

Process: Thermoforming. The roll of bioplastic sheet made from oat residue is placed in a preheating device that is connected to the thermoforming machine. The thermoforming machine contains a series of molds to shape the food trays or other desired configurations.

The bioplastic sheet is heated between 50 and 60 degrees Celsius. The bioplastic sheet is then automatically transported to the thermoforming machine. The bioplastic sheet is further heated by the resistors of this machine, to a temperature ranging from 100 to 120 degrees Celsius so that the mold can form and then cut the tray.

Once the bioplastic sheet is heated, the molds begin to perform their forming function, giving blows that form and cut the trays or other desired configurations. The trays (or other desired products) fall onto a conveyor belt to be packed. The packing may be either automatically or manually.

Process: Injection. Once the material is mixed, the material is poured into a hopper to carry out extrusion processes where the material is heated from 180 to 200 degrees Celsius, to melt and couple together and is pushed by two screws, until the mixture reaches the head of the injection machine. The mixture is then expelled from the injection machine and fills the cavities of the cutlery (or other desired configuration) mold.

Once the cavities are filled with the oat residue bioplastic mixture, the machine automatically opens the mold. A robotic, automated arm removes the cutlery to place same on a conveyor belt that takes the finished product (cutlery or other desired product) to be packed automatically or manually.

The bioplastic products produced by the present invention may include trays for meat, poultry and fish products, as well as containers for baked goods and other meat items such as rotisserie chicken. The bioplastic products may also include cutlery and straws.

The bioplastic products produced by the present invention have several desirable attributes. These bioplastic products are safe for food contact and free from toxins. The bioplastic products have a heat tolerance of up to 220° C. and a low temperature tolerance down to −17° C. The bioplastic products are resistant to liquid and grease and also safe to use in a microwave.

The shelf life or storage conditions of the bioplastic products of the present invention range from 24 to 26 months. Properly discarded, the biodegradation and compostability attributes of the discarded bioplastic products of the present invention are activated by the attraction of microorganisms and bacteria found in nature, industrial composts, and landfills, both aerobically and anaerobically. The bioplastic products produced using the present invention may be decomposed in a variety of environmental conditions. For example, in an industrial composting facility, the decomposition time of the bioplastic products manufactured by the present invention is about twenty-six (26) weeks. In landfills, the decomposing time ranges from between 18 to 24 months.

There are also environmental advantages with the use of the bioplastics produced under the present invention in terms of carbon footprint, energy consumption and water footprint. For example, the carbon footprint (CO²) of the bioplastics produced under the present invention is 3.5 tons CO² per 10 tons of material (as compared to 30 tons CO² per 10 tons of material for plastics). The energy consumption in the manufacture of bioplastics under the present invention is in the range of 7,654 to 10,670 kilowatts/hr. (kWh) usage per ton of material (as compared to 22,200 to 33,300 kilowatts/hr. (kWh) usage per ton of material for plastics). The water footprint of the bioplastics produced under the present invention is 10 m3 of water usage per ton of material (as compared to 10 m3 of water usage per ton of material for plastics).

These statistics demonstrate an 88% reduction in carbon footprint, 68% reduction of energy consumption, and a 90% reduction of water consumption for bioplastics produced under the present invention as compared to plastics.

With bioplastic derived from oat residue, different products can be manufactured in plastic processes, such as injection, extrusion, thermoforming and their derivatives. The defining characteristics resulting in bioplastic products manufactured under the present invention are that such products are biobased, biodegradable and compostable, allowing for application in several industries. The present invention has applications in various industries, including, but not limited to, the plastic, food, agro-industry, cosmetics, and the packaging industry.

The various embodiments described herein may be used singularly or in conjunction with other similar methods. The present disclosure includes preferred or illustrative embodiments of specifically described methods, apparatuses, assemblies, and systems. Alternative embodiments of such methods, apparatuses, assemblies, and systems can be used in carrying out the invention as described herein. Other aspects and advantages of the present invention may be obtained from a study of this disclosure and the drawings.

We claim:

1. A method of manufacturing bioplastic from oatmeal hull residue, said steps comprising:
66.5% of polypropylene in any of its forms (percentage varies depending on the product to be made) and 30% of oat residue (percentage varies depending on the product to be made) are mixed until a homogeneous mixture is obtained.
Subsequently, 1.5% of the additive is added (any additive used in adhesive coating applications, mold compounds and composites is added) to the mixture to facilitate coupling with the pelletizing machine and improve its fluidity.
Subsequently, 1% of the plasticizer (polyurethane, polyvinyl chloride, ethylene-vinyl acetate, thermoplastic rubber, silicone, natural or synthetic rubber) is added to the mixture to add resistance and flexibility characteristics; and
Finally, 1% of the lubricant (zinc stearate, magnesium stearate, calcium stearate, aluminum stearate, lithium stearate, sodium stearate, oleamide, polyolefin waxes) is added to the mixture to facilitate the transport of the mixture in the pelletizing machine.

2. A method of manufacturing bioplastic from oatmeal hull residue, said steps comprising:
formulating an oat residue bioplastic mixture, the steps of which comprise:
selecting a bioplastic product to be made;
obtaining a predetermined amount of oatmeal hull residue to form a fiber, said predetermined amount of said oatmeal hull residue dependent upon said bioplastic product selected;
first adding a predetermined amount of polypropylene and said fiber to form a mixture;
second adding a predetermined amount of an additive to said mixture;
third adding a predetermined amount of a plasticizer to said mixture;
fourth adding a predetermined amount of a lubricant to said mixture, the result of which results in said oat residue bioplastic mixture; and
mixing said oat residue bioplastic mixture for a predetermined amount of time until said oat residue bioplastic mixture is homogeneous;
pouring said oat residue bioplastic mixture into a hopper;
transferring said oat residue bioplastic mixture;
heating said oat residue bioplastic mixture to a predetermined temperature for a predetermined period of time, said temperature and said time period sufficient to transform said oat residue bioplastic mixture from a solid state to a homogeneous viscous state;
filtering said oat residue bioplastic mixture through a mesh sufficient to remove impurities;
injecting said oat residue bioplastic mixture into a mold having a predetermined configuration of the desired products;
transporting said oat residue bioplastic mixture along a conveyor belt;
actively cooling said oat residue bioplastic mixture on said conveyor belt;
cutting said oat residue bioplastic mixture into pellets; and
collecting said pellets of said oat residue bioplastic mixture, wherein, the resulting oatmeal hull residue-based bioplastic is biobased, biodegradable and compostable.

3. The method of manufacturing bioplastic from oatmeal hull residue, as recited in claim 2, wherein the amount of fiber added to said mixture is 30% of said mixture.

4. The method of manufacturing bioplastic from oatmeal hull residue, as recited in claim 3, wherein the amount of polypropylene added to said mixture is 66.5% of said mixture.

5. The method of manufacturing bioplastic from oatmeal hull residue, as recited in claim 4, wherein the amount of additive added to said mixture is 1.5% of said mixture.

6. The method of manufacturing bioplastic from oatmeal hull residue, as recited in claim 5, wherein the amount of plasticizer added to said mixture is 1.0% of said mixture.

7. The method of manufacturing bioplastic from oatmeal hull residue, as recited in claim 6, wherein the amount of lubricant added to said mixture is 1.0% of said mixture.

8. The method of manufacturing bioplastic from oatmeal hull residue, as recited in claim 7, wherein said plasticizer is ethylene-vinyl acetate.

9. The method of manufacturing bioplastic from oatmeal hull residue, as recited in claim 8, wherein said lubricant is zinc stearate.

10. The method of manufacturing bioplastic from oatmeal hull residue, as recited in claim 9, wherein the variants of said fiber range from 1% to 80%.

11. The method of manufacturing bioplastic from oatmeal hull residue, as recited in claim 10, wherein the variants of said polypropylene range from 15% to 99%.

12. The method of manufacturing bioplastic from oatmeal hull residue, as recited in claim 11, wherein the variants of said additive range from 0.5% to 7%.

13. The method of manufacturing bioplastic from oatmeal hull residue, as recited in claim 12, wherein the variants of said plasticizer range from 1.0% to 7%.

14. The method of manufacturing bioplastic from oatmeal hull residue, as recited in claim 13, wherein the variants of said lubricant range from 1.0% to 7%.

15. The method of manufacturing bioplastic from oatmeal hull residue, as recited in claim 6, wherein said plasticizer is selected from a group consisting of polyurethane, polyvinyl chloride, ethylene-vinyl acetate, thermoplastic rubber, silicone, and natural or synthetic rubber.

16. The method of manufacturing bioplastic from oatmeal hull residue, as recited in claim 7, wherein said lubricant is a compound selected from the group consisting of magnesium stearate, calcium stearate, aluminum stearate, lithium stearate, sodium stearate, oleamide and polyolefin waxes.
